(19) United States
(12) Patent Application Publication
(10) Pub. No.: US 2004/0038607 A1
(43) Pub. Date: Feb. 26, 2004

(54) Non-slip nonwoven liner

(75) Inventors: Bruce Scott Williamson, Alpharetta, GA (US); Ryan Clinton Frank, Alpharetta, GA (US); Gina Kay Rolsten, Lawrenceville, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/225,957

(22) Filed: Aug. 22, 2002

(51) Int. Cl. B32B 27/12; B32B 27/04; D04H 1/00; D04H 3/00; B32B 5/26; B32B 5/02

(52) U.S. Cl. 442/101; 442/400; 442/381; 442/149; 442/401; 442/394

(57) ABSTRACT

The present invention relates to a non-slip liner or mat which is soft, durable, breathable, allows for air circulation, is mildew resistant, is a barrier and is repositionable. The liner or mat of the present invention is a laminate of at least two layers of nonwoven webs. In addition, the liner or mat of the present invention has non-slip coating applied to a side of at least one of the first and second layers not in the surface to surface to surface relationship with the other layer. The non-slip liner can be used to protect shelves, drawers, tables and the like from damage during use.

### FIELD OF THE INVENTION

The present invention relates to a protective non-slip liner or mat usable in locations, such as, for example, in drawers, on shelves, in closets, in organizers or other hard surfaces.

### BACKGROUND OF THE INVENTION

Protective products designed for shelves, drawers, closets, organizers and the like, commonly called “liners”, are known in the art. These liners are used to protect from damage both the surface which they are attached or laid upon and the items stored on the liners. In addition, liners also help hide imperfection on surfaces of shelves, drawers and the like, while provide an aesthetically pleasing surface for a user of the shelves, drawers, closets, organizers or other hard surfaces.

Numerous product designs are available; however, the product designs available tend to fall within two general categories. The first category of liners includes liquid impervious materials such as film materials or papers coated or impregnated with a liquid impervious material. These types of liners are generally called “contact paper”. Typically, the contact paper liners of the first category have one or more of the following the drawbacks such as being thin, do not provide cushion or softness, are not breathable and generally can not be repositioned once place on a surface. Examples of liners of the first category are shown in, for example, U.S. Pat. No. 4,137,356 to Shoemaker et al., U.S. Pat. No. 4,947,999 to Warp, and U.S. Pat. No. 4,380,564 to Cancio et al.

The second category of liners is generally soft, resilient and anti-skid. This category generally includes foam-like products. Typically, in this category, the liners do not include an adhesive on the side of the product that comes into contact with the surface to be protected. The liner is held in place by the high frictional nature of the foam-like surface. Examples of such products include products available from Griptex Industries, Inc., Cartersville, Ga. under the trade designation “Wonderliner”. The liner products in this category have the drawbacks of not being breathable, the products tend to absorb and hold spills of liquids, and the side of the liner away from the surface being protected has a high coefficient of friction making it difficult to place items on higher shelves since the surface does not allow for sliding, among others. Furthermore, these liners are not aesthetically pleasing, i.e. do not have a cloth-like appearance, and in the case of open mesh foams, do not provide protection of the surface being protected from spills of liquids and particles, such as flour, salt or other particle-like substances, including dust. Liner products of the foam-like type are described in U.S. Pat. No. 6,130,174 to Hawley et al. or U.S. Pat. No. 5,707,903 to Schottenfeld.

Many of the prior liners have a contact adhesive on the side of the liner that is to be attached to the substrate the liner is intended to protect. However, with a contact adhesive on one surface of the liner, the liner can not be easily removed after the liner is adhered to the substrate to be protected. In addition, the contact adhesive may damage the surface being protected when the liner is removed at the end of its useful life. This is especially true for painted or otherwise finished surfaces. Liners having anti-skid coatings are also known in the art, as is shown in WO 01/26893 to Owens et al. In this published patent application, a low tack adhesive is applied to the film liner material. The low tack nature of the adhesive allows for the liner to be moved and repositioned on a substrate before adhesion to that substrate.

There is a need for a liner with all of the positive features of the two category of liners described above, including breathability, durability, allows air circulation, provides cushioning and softness, provides protection to shelving from dust, provides protection from spills of fluids and particle-like substances such as salt, is mildew resistant, is washable and does not have many of the disadvantages of the first and second category of liners. There is a need for a liner providing the above properties which is also repositionable and aesthetically pleasing, providing a cloth-like appearance.

### SUMMARY OF THE INVENTION

The present invention provides a liner or mat which is soft, durable, breathable, allows for air circulation, mildew resistant, has barrier properties and is repositionable. Further, the liner of the present invention protects shelving and other horizontal surfaces from damage caused by dirt, dust, spills of liquids and spills of particle-like substances, while providing a cloth-like appearance.

In a first aspect of the present invention, the liner or mat of the present invention is a laminate of at least two layers of nonwoven webs, wherein at least on the nonwoven web layers is a nonwoven web of meltblown filaments. More specifically, the liner or mat of the first aspect of the present invention has a first layer which is a nonwoven web and a second layer of thermoplastic meltblown filaments, wherein the first and second layers are adjacent to each other and are bonded together. In addition, the liner or mat of the present invention has non-slip coating applied to a side of at least one of the first and second layers not adjacent to the other layer.

In furtherance of the first aspect of the present invention, the first layer of the liner or mat is a nonwoven web of thermoplastic spunbond filaments. Thermoplastic spunbond filaments provide strength to the liner of the present invention while being cost efficient.

In a second aspect of the present invention, the non-slip liner is a laminate having a first layer which is a nonwoven web, a second layer which acts as a barrier, a third layer which is a nonwoven web. The second layer is sandwiched between first and third layers such that one side of the first layer is adjacent to one side of the second layer and the third layer is adjacent to other side of the second layer. The second layer acts as a barrier and may be a liquid impervious nonwoven web or a film material. A non-slip coating applied to the side of at least one of the first and third layers not adjacent to the second layer. Having a nonwoven web on both sides of the second layer improves the overall durability of the liners or mats. In this aspect of the invention, it is preferred, but not required, that both the first nonwoven layer and the third nonwoven layer are spunbond layers.

Another aspect of the present invention is an article containing the non-slip liner or mat of the present invention. The article of the present invention has a substantially flat, substantially horizontal and upwardly facing surface. On this upwardly facing surface, a non-slip liner or mat of the present invention is placed. The non-slip liner or mat may be a laminate having a first layer containing a thermoplastic nonwoven web, a second layer containing thermoplastic meltblown filaments wherein the first and second layers are adjacent to each other and are bonded together with a non-slip coating applied to a side of at least one of the first and second layers not adjacent to the other layer. In the alternative, the non-slip liner or mat may a laminate having a barrier layer sandwiched between two nonwoven webs. In this aspect of the present invention, the non-slip coating of the laminate is in contact with the upwardly facing surface. The non-slip liner or mat protects the upwardly facing surface.

### BRIEF DESCRIPTION OF THE DRAWINGS

FIGS. 1A and 1B show a three layer non-skid liner or mat of the first aspect of the present invention.

FIGS. 2A and 2B show a four layer non-skid liner or mat of the second aspect of the present invention.

Definitions

As used herein, the term “comprising” is inclusive or open-ended and does not exclude additional unrecited elements, compositional components, or method steps.

As used herein, the term “fiber” includes both staple fibers, i.e., fibers which have a defined length between about 19 and about 50 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

As used herein, the term “meltblown fibers” means fibers formed by extruding a molten thermoplastic material through a plurality of fine, usually circular, die capillaries as molten threads or fibers into converging high velocity, usually hot, gas (e.g. air) streams which attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblown fibers are microfibers, which may be continuous or discontinuous, and are generally smaller than 10 microns in average diameter. The term “meltblown” is also intended to cover other processes in which a high velocity gas, (usually air) is used to aid in the formation of the fibers, such as melt spraying or centrifugal spinning.

As used herein, the term “coform nonwoven web” or “coform material” means composite materials comprising a mixture or stabilized matrix of thermoplastic filaments and at least one additional material, usually called the “second material” or the “secondary material”. As an example, coform materials may be made by a process in which at least one meltblown die head is arranged near a chute through which the second material is added to the web while it is forming. The second material may be, for example, an absorbent material such as fibrous organic materials such as woody and non-wood cellulosic fibers, including regenerated fibers such as cotton, rayon, recycled paper, pulp fluff; superabsorbent materials such as superabsorbent particles and fibers; inorganic absorbent materials and treated polymeric staple fibers and the like; or a non-absorbent material, such as non-absorbent staple fibers or non-absorbent particles. Exemplary coform materials are disclosed in commonly assigned U.S. Pat. No. 5,350,624 to Georger et al.; U.S. Pat. No. 4,100,324 to Anderson et al.; and U.S. Pat. No. 4,818,464 to Lau et al.; the entire contents of each is hereby incorporated by reference.

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having and average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety. “Bonded carded web” refers to webs that are made from staple fibers which are sent through a combing or carding unit, which separates or breaks apart and aligns the staple fibers in the machine direction to form a generally machine direction-oriented fibrous nonwoven web. Such fibers are usually purchased in bales which are placed in an opener/blender or picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

“Airlaying” or “airlaid” is a well known process by which a fibrous nonwoven layer can be formed. In the airlaying process, bundles of small fibers having typical lengths ranging from about 3 to about 19 millimeters (mm) are separated and entrained in an air supply and then deposited onto a forming screen, usually with the assistance of a vacuum supply. The randomly deposited fibers then are bonded to one another using, for example, hot air or a spray adhesive.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random.

As used herein, the term “pattern bonded” refers to a process of bonding a nonwoven web in a pattern by the application of heat and pressure or other methods, such as ultrasonic bonding. Thermal pattern bonding typically is carried out at a temperature in a range of from about 80° C. to about 180° C. and a pressure in a range of from about 150 to about 1,000 pounds per linear inch (59-178 kg/cm). The pattern employed typically will have from about 10 to about 250 bonds/inch² (1-40 bonds/cm²) covering from about 5 to about 30 percent of the surface area. Such pattern bonding is accomplished in accordance with known procedures. See, for example, U.S. Design Pat. No. 239,566 to Vogt, U.S. Design Pat. No. 264,512 to Rogers, U.S. Pat. No. 3,855,046 to Hansen et al., and U.S. Pat. No. 4,493,868, supra, for illustrations of bonding patterns and a discussion of bonding procedures, which patents are incorporated herein by reference. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

As used herein, the term “non-slip” is intended to mean that the liner or mat of the present invention, when placed on a surface to be protected, does not slide or does not easily slide on the surface being protected under normal usage. As used herein, the phrase “substantially flat, substantially horizontal and upwardly facing surface” refers to a surface in which an item can be place, stored or displayed in a position such that the item will not fall from under its own weight or center or gravity. The surface under this definition may be at an angle provided that the angle is not such that the center of gravity will cause the item to fall. The surface is substantially flat meaning the there may be some surface imperfections or other surface defects not substantial enough to cause the item to fall under its own weight or center of gravity. Examples of such surfaces include, but are not limited to, shelves and drawers in cabinets, refrigerators or pieces of furniture such as desk, chest of drawers and armoires, in closets and the like. Other surfaces include tabletops, desk tops and the like.

### DETAILED DESCRIPTION

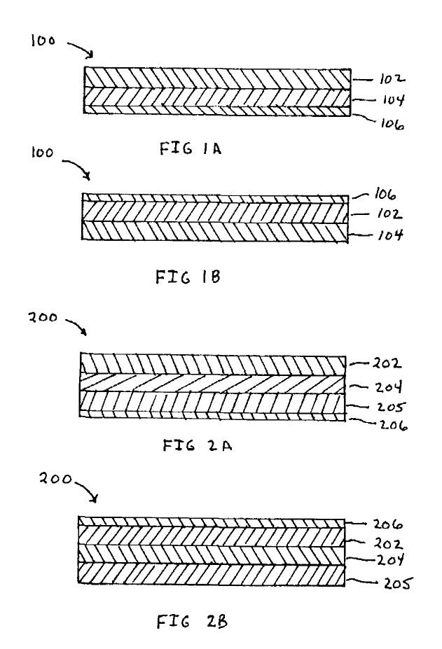

The non-slip liner or mat of the present invention includes a multilayer laminate having at least two nonwoven webs and a non-slip coating applied to at least one side of a nonwoven web of the multilayer laminate. The nonwoven web imparts the properties of softness, durability, breathability, mildew resistance and the barrier properties to the liner or mat while the non-slip coating provides repositionability to the liner or mat. Further, the liner or mat of the present invention protects shelving and other horizontal surfaces from damage caused by dirt, dust, spills of liquids and spills of particle-like substances, while providing a cloth-like appearance In order to obtain a better understanding of the non-slip liner or mat of the first aspect of the present invention, FIG. 1A and FIG. 1B show a three-layer liner or mat 100 of the present invention. A first nonwoven web layer 102 is adjacent to the second layer of thermoplastic meltblown filaments 104. The first layer 102 and the second layer 104 are bonded together using bonding methods described below. In addition, a non-slip coating 106 is applied to at the side of the second layer 104 not adjacent to the first layer 102, as is shown in FIG. 1A or the non-slip coating 106 is applied to at least the side of the first layer 102 not adjacent to the second layer 104, as is shown in FIG. 1B. It is noted that the non-slip coating may be applied to both sides of the liner; however, this is generally not preferred unless non-slip properties are needed on both sides of the liner.

The non-slip liner or mat of the first aspect of the present invention is a laminate of at least two nonwoven webs, wherein at least one of the nonwoven web layers is a nonwoven web of meltblown filaments. More specifically, the liner or mat of the present invention has a first layer which is a nonwoven web and a second layer of thermoplastic meltblown filaments wherein the first and second layers are adjacent to each other and are bonded together.

The first layer of the laminate may be any type of nonwoven web known. For example, the first layer may be a spunbond nonwoven web, a meltblown nonwoven web, an air-laid nonwoven web, coform nonwoven web or a bonded carded web. In addition, the first layer may be a laminate of two or more of these nonwoven webs. Selection of the first layer will determine the properties of the resulting liner or mat. For example, spunbond layers are known to impart strength to nonwoven web laminates and other nonwoven webs are know to have other properties, such as, in the case of coform and airlaid nonwoven webs, absorbency.

In a second aspect of the present invention, the non-slip liner or mat of the present invention has at least four layers. In order to obtain a better understanding of the liner or mat of the second embodiment of the present invention, FIG. 2A and FIG. 2B show a four layer liner or mat 200 of the present invention having at least two nonwoven layers. A first nonwoven web layer 202 is adjacent to the second layer 204. The first layer 202 and the second layer 204 are bonded together using bonding methods described below. In addition, a third layer, which is a nonwoven web 205, is adjacent to the second layer 204 on the side of the second layer 204 opposed to the side adjacent to the first layer. The third layer is bonded to the second layer using bonding methods described below. In addition, a non-slip coating 206 is applied to at least the side of the third layer 205 not adjacent to the second layer 204, as is shown in FIG. 2A or the non-slip coating 206 is applied to at least the side of the first layer 202 not adjacent to the second layer 204, as is shown in FIG. 2B. Again, it is noted that the non-slip coating may be applied to both sides of the liner; however, this is generally not preferred unless non-slip properties are need on both sides of the liner. Preferably, the non-slip coating is applied to the side of the liner which will come into contact with the surface the liner is intended to protect, thereby preventing the liner from moving during use. The first layer of the laminate of the second aspect of the present invention may be any type of nonwoven web known. For example, the first layer may be a spunbond nonwoven web, a meltblown nonwoven web, an air-laid nonwoven web, coform nonwoven web or a bonded carded web. In addition, the first layer may be a laminate of two or more of these nonwoven webs. As is noted above, selection of the first layer will determine the properties of the resulting liner or mat.

The second layer of the laminate of the second aspect of the present invention is a barrier layer. This layer prevents liquids and particles from passing through the non-slip liner or mat to the surface in which the liner or mat is protecting. The second layer can be any material that will provide barrier properties; however, it is desirable that the barrier is a nonwoven web of thermoplastic meltblown filaments or a film material. If a film material is selected, it is desirable that the film is breathable. It is most desirable that the barrier layer is a nonwoven web of thermoplastic meltblown filaments.

The barrier layer, when a film, may be prepared from a polymeric film material. Examples of polymers which can be used to form the barrier layer include, polymers and copolymers of olefins, nylon and polyesters. The actual polymer used to prepare the film is not critical to the invention. It is desirable to use polymer films having a low cost. Therefore, films of polyethylene or polypropylene are desired due to the low cost and reasonable strength provided by these polymers at an effective film thickness. The film may be a single layer film of a multilayer film. In addition, it is desirable, but not required, that the film of the barrier layer is breathable. Examples of breathable films may be prepared using method known in the art, such as those described in U.S. Pat. No. 6,309,746 to McCormack et al., which is hereby incorporated by reference in its entirety.

As with the first layer of the laminate, the third layer of the laminate may be any type of nonwoven web known. For example, the third layer may be a spunbond nonwoven web, a meltblown nonwoven web, an air-laid nonwoven web, a coform nonwoven web or a bonded carded web. In addition, the third layer may be a laminate of two or more of these nonwoven webs.

The layers of the multilayer laminate may be generally bonded in some manner as they are produced in order to give them sufficient structural integrity to withstand the rigors of further processing into a finished product. Bonding can be accomplished in a number of ways such as hydroentanglement, needling, ultrasonic bonding, adhesive bonding and thermal bonding. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

Thermal bonding of a multilayer laminate may be accomplished by passing the same between the rolls of a calendering machine. At least one of the rollers of the calender is heated and at least one of the rollers, not necessarily the same one as the heated one, has a pattern which is imprinted upon the laminate as it passes between the rollers. As the laminate passes between the rollers, the laminate is subjected to pressure as well as heat. The combination of heat and pressure applied in a particular pattern results in the creation of fused bond areas in the multilayer laminate where the bonds thereon correspond to the pattern of bond points on the calender roll.

Various patterns for calender rolls have been developed. One example is the Hansen-Pennings pattern with between about 10 to 25% bond area with about 100 to 500 bonds/square inch as taught in U.S. Pat. No. 3,855,046 to Hansen and Pennings. Another common pattern is a diamond pattern with repeating and slightly offset diamonds. The particular bond pattern can be any pattern known to those skilled in the art. The bond pattern is not critical for imparting the properties to the liner or mat of the present invention.

The exact calender temperature and pressure for bonding the multilayer laminate depend on thermoplastic polymers from which the nonwoven webs and/or film material are made. Generally for multilayer nonwoven web laminates formed from polyolefins, the preferred temperatures are between 150° and 350° F. (66° and 177° C.) and the pressure between 300 and 1000 pounds per linear inch. More particularly, for polypropylene, the preferred temperatures are between 270° and 320° F. (132° and 160° C.) and the pressure between 400 and 800 pounds per linear inch. However, the actual temperature and pressures need are highly dependent of the particular thermoplastic polymers used in each of the layers. The actual temperature and pressure used to bond the layers of the laminate together will be readily apparent to those skilled in the art. Of the available method for bonding the layer of the multilayer laminate nonwoven web usable in the present invention, thermal and ultrasonic bonding are preferred due to factors such as materials cost and ease of processing.

Suitable thermoplastic polymers useful for preparing the individual nonwoven layers of the liner or mat of the present invention include polyolefins, polyesters, polyamides, polycarbonates, polyurethanes, polyvinylchloride, polytetrafluoroethylene, polystyrene, polyethylene terephathalate, biodegradable polymers such as polylactic acid and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

Many polyolefins are available for fiber production, for example polyethylenes such as Dow Chemical's ASPUN 6811A linear low-density polyethylene, 2553 LLDPE and 25355 and 12350 high density polyethylene are such suitable polymers. The polyethylenes have melt flow rates in g/10 min. at 190° F. and a load of 2.16 kg, of about 26, 40, 25 and 12, respectively. Fiber forming polypropylenes include, for example, Basell's PF-015 polypropylene. Many other polyolefins are commercially available and generally can be used in the present invention. The particularly preferred polyolefins are polypropylene and polyethylene.

Examples of polyamides and their methods of synthesis may be found in “Polymer Resins” by Don E. Floyd (Library of Congress Catalog number 66-20811, Reinhold Publishing, N.Y., 1966). Particularly commercially useful polyamides are nylon 6, nylon-6,6, nylon-11 and nylon-12. These polyamides are available from a number of sources such as Custom Resins, Nyltech, among others. In addition, a compatible tackifying resin may be added to the extrudable compositions described above to provide tackified materials that autogenously bond or which require heat for bonding. Any tackifier resin can be used which is compatible with the polymers and can withstand the high processing (e.g., extrusion) temperatures. If the polymer is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ®and ARKON®P series tackifiers are examples of hydrogenated hydrocarbon resins. ZONATAC®501 Lite is an example of a terpene hydrocarbon. REGALREZ®hydrocarbon resins are available from Hercules Incorporated. ARKON®P series resins are available from Arakawa Chemical (USA) Incorporated. The tackifying resins such as disclosed in U.S. Pat. No. 4,787,699, hereby incorporated by reference, are suitable. Other tackifying resins which are compatible with the other components of the composition and can withstand the high processing temperatures may also be used.

Of these thermoplastic polymers, polyolefins are desirably used. In particular polyethylene and polypropylene are most desirable.

The multilayer laminate used in the non-slip liner or mat of the present invention has an overall basis weight, based on the weight of the nonwoven laminate only of from about 0.4 to 12 ounces per square yard (osy) (about 13.6 to 339 grams per square meter (gsm)), or more particularly from about 1.0 to about 7.0 osy (about 34 to about 237 gsm). Most preferably, the basis weight is between about 2.0 and 6.0 osy (67.8 to about 203 gsm), since this basis weight has a good balance between thickness and cushioning.

In one embodiment of the non-slip liner or mat of the present invention, the multilayer nonwoven web laminate includes at least one layer formed from spunbond filaments and the second layer is formed from meltblown filaments, such as a spunbond/meltblown (SM) nonwoven web laminate. In another embodiment, the multilayer nonwoven web laminate includes at least one layer formed from meltblown filaments separating two layers formed from spunbond filaments, such as a spunbond/meltblown/spunbond (SMS) nonwoven web laminate. In this case, the first and third layers are spunbond nonwoven webs. Examples of these nonwoven web laminates are disclosed in U.S. Pat. No. 4,041,203 to Brock et al., U.S. Pat. No. 5,188,885 to Timmons et al, et al, and U.S. Pat. No. 4,374,888 to Bornslaeger which are all herein incorporated by reference in their entirety. The SMS nonwoven web laminate may be made by sequentially depositing onto a moving forming belt first a spunbond fabric layer, then a meltblown fabric layer and last another spunbond layer and then bonding the laminate in a manner described below. Alternatively, the layers may be made individually, collected in rolls, and combined in a separate bonding step. Any of the bonding methods described above may be used; however, it is preferred that thermal bonding or ultrasonic bonding is used to avoid the additional cost associated with the other bonding steps, such as increased material cost, in the case of adhesive bonding or the need to dry the laminate, such as in the case of hydroentangling.

When thermoplastic spunbond filaments are used as the first nonwoven layer and the third nonwoven layer, the thermoplastic spunbond filaments impart strength and durability to the laminate. Generally, each spunbond layer has a basis weight of about 0.2 to about 4.0 osy (about 6.8 to about 136 gsm). Preferably, the basis weight of each spunbond layer should be in the range of about 0.8 to about 2.5 osy. In addition, it is preferred, but not required, that both sides of the meltblown filaments are covered with a spunbond nonwoven web.

The meltblown filament layer of the multilayer laminate imparts barrier properties and cushioning properties to the laminate. Generally, the meltblown layer provides between about 0.2 to about 4.0 osy (about 68 to about 136 gsm) of basis weight to the multilayer laminate. Preferably, the basis weight of the meltblown layer is in the range of about 0.5 to about 1.5 osy (about 17 gsm to about 51 gsm). It is further noted that the meltblown layer may be formed using one meltblown die or it may be formed by using several meltblown dies in series. It is not critical to the present invention how the meltblown layer is formed.

The filaments and fibers used in the production of the nonwoven webs of the laminate used in the liner or mat of the present invention may be monocomponent fibers or filaments, multicomponent fiber or filaments, or multiconstituent fibers or filaments. In addition, the fibers or filaments may be round or shaped into shapes such as ribbons, multilobal shapes and the like.

When the laminate of the present invention contains a film barrier layer, the laminate may be made by process known in the art, such as, for example U.S. Pat. No. 6,309,746 to McCormack et al., which is hereby incorporated by reference.

The non-slip coating of the liner or mat of the present invention can be any material which will hold the liner in place during normal use. The only requirement is the that material have sufficient tack to hold the liner to the surface being protected, but a sufficiently low enough peel strength to allow the user to remove or reposition the liner without damaging the liner or the surface to which the liner is attached. Examples of such material include, for example, adhesives and foam materials.

Adhesives usable in the present invention should have a high coefficient of friction and a low degree of tack. The adhesive may be a solvent-based adhesive, a dry adhesive, an aqueous-based adhesive or a hot-melt adhesive. Generally, the coefficient of friction of the adhesive selected should be such that the liner or mat does not slip on the surface to which it is protecting during use. Further, the degree of tack should be such that the liner may be peeled from the surface in which it is attached without damaging the surface. In addition, the laminate should be strong enough so that the laminate is not damaged during the positioning and repositioning of the liner or mat on the surface to be protected.

Examples of adhesives usable in the present invention include the following commercially available adhesives such as Henkel Adhesives Corp. EUROMELT 80-8628, Huntsman RT-2115, Finley H2190-401 and National Starch Lite-Lok 70-003A. From an ease of handling standpoint and an environmental standpoint, it is preferred that a hot-melt adhesive or an aqueous based adhesive is used.

The non-slip coating may be applied to the multilayer laminate to form the non-slip liner or mat of the present invention by any technique know in the art. The non-slip coatings may be sprayed, printed using inkjet printing, rotogravure printing, brush painted, slot coated or the like. The non-slip coating be applied in pattern or may be randomly applied to the multilayer laminate. The only requirement is that there is sufficient non-slip coating applied to the multilayer laminate so that the liner does not slip out of place during use. Generally, the non-slip coating should cover at least about 50% of the area of the layer to which the non-slip coating is applied. Preferably, the non-slip coating should cover between about 75% and about 100% of the area of the layer to which the non-slip coating is applied.

The basis weight of the non-slip coating on the multilayer nonwoven web is not critical to the invention, so long as there is sufficient non-slip material to hold the liner in place during use. From the standpoint of cost, the amount of the non-slip coating should be less that about 1 osy (about 34 gsm) and preferably between about 0.02 osy to about 0.34 osy (about 1 to about 10 gsm), most preferably between about 0.04 osy and about 0.24 osy (about 2 to about 8 gsm).

The aesthetics of the liner or mat of the present invention can be easily changed by adding pigment or dyes to the polymer mixture used to form the fiber or filaments of each nonwoven web. Other methods of changing the aesthetics include printing patterns onto the surface of the liner which does not contain the non-slip coating using printing methods such as rotogravure printing or inkjet printing. Further, the aesthetics of the liner can also be changed by modifying the bond pattern to bond the individual layer of the laminate together.

The surface of the liner may also be prepared to have a three dimension configuration, such as a series of protrusions extending away from the non-slip surface. The nonwoven web making up the layer distal to the non-slip layer may desirably have protrusions to help air circulation around items stored on the liner. Examples of nonwoven webs having such protrusion are shown in U.S. Pat. No. 5,858,515 to Stokes et al, the contents of which are hereby incorporated by reference. Another patent showing a nonwoven having protrusions is U.S. Pat. No. 4,741,941 to Engelbert et al., the contents of which are also incorporated by reference. In Englebert et al. a nonwoven web with hollow projections which extend outward from the surface of the nonwoven web is disclosed.

In addition, the liner of the present invention may further have properties such as odor control, insect control or a fragrance. These properties may be imparted to the liner by adding odor controlling agents, fragrances, or insecticides to one or more of the layers of the liner or to the non-slip material. One effective way to impart these properties to the nonwoven web is to use a coforming process to form the meltblown second layer. Coforming is described in detail in U.S. Pat. No. 4,100,324 to Anderson et al, which is hereby incorporated by reference. In using a coforming process, a solid fragrance, odor control agent, or insecticide is added as a secondary material to the stream of meltblown filaments forming the second layer of the multilayer laminate. The amount of secondary material added will depend on the specific secondary material and the properties of the secondary material. Other methods of imparting these properties to the multilayer laminate include including these material in the filaments used to form the nonwoven webs, coating the multilayer laminate with these material and the like. Other methods of imparting these properties to the multilayer nonwoven web will be apparent to those skilled in the art.

The non-slip liner or mat of the present invention can be used in a wide variety of locations. Ideally, the non-slip liner is placed on a substantially flat, substantially horizontal and upwardly facing surface. Examples of such surfaces include on shelves and drawers in cabinets, refrigerators, closets and pieces of furniture, such as desks, chest of drawers, armoires and the like. In addition, the non-slip liner can be used as a place mat on a table, a drink coaster or other similar protective liner for hard surfaces on furniture and the like. The advantage of the non-slip liner or mat of the present invention is that the liner or mat will not readily move during use and will tend to remain at the location in which it is places, without damaging the surface which it is protecting.

The non-slip liner or mat of the present invention can be packaged into a stack of sheets or be placed on rolls with or without perforations. In addition, the non-slip liner or mat of the present invention can be easily cut into desired shapes often required to avoid supports of odd shapes often found in cabinets and the like.

### EXAMPLE

A multilayer laminate having a layer of 0.8 osy (27 gsm) polypropylene meltblown sandwiched between two layers of 1.5 osy (51 gsm) polypropylene spunbond was prepared in accordance with the U.S. Pat. No. 5,188,885 to Timmons. The layers of the multilayer laminate were bonded together using a 400S Rec Fab pattern roll resulting in a multilayer nonwoven laminate having a basis weight of 3.8 osy (129 gsm). On one of the spunbond layers, Henkel Adhesive Corp. EUROMELT 80-8626 was applied by hot slot coating at a coating lever of 0.12 osy (4 gsm) to form a non-skid coating on the laminate. The laminate was cut to an appropriate size so that it could be used as a shelf liner and placed on a shelf as a liner. The liner was easily repositionable during its initial placement on the shelf; however, the liner did not move for its originally placed position during normal usage, but was easily removable at the end of its useful life.

The static coefficient of friction was tested for the above shelf liner and a mesh foam shelf liner available from Griptex, Industries under the trade designation WONDERLINER using the ASTM-D1894 test method. The test was run for various surfaces of use including, a ceramic surface, a sanded wood surface and a vinyl floor surface. Both sides of the liners were tested and the results of the test are shown in Table 1.

TABLE 1

| | Static coefficient | | |
|---|---|---|---|
| | of friction measure under ASTM-D1894 | | |
| | Ceramic Surface | Sanded Wood | Vinyl Flooring |
| Example adhesive | 4.1 | 1.65 | 4.2 |
| side | | | |
| Example non- | 0.38 | 0.51 | 0.51 |
| adhesive side | | | |
| Wonderliner side 1 | 4.0 | 1.9 | 4.2 |
| Wonderliner side 2 | 3.9 | 1.9 | 3.8 |

As can be seen in Table 1, the liner of the present invention provides the advantage of a lower coefficient of friction for the surface not in contact with the shelf surface than the Wonderliner, while providing similar coefficient of friction for the surface in contact with the shelf as the Wonderliner. This means that items can be easily slid across the surface of the liner, making for easy removal of items on the liner of the present invention.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

We claim:

1. A non-slip liner comprising
a first layer comprising a thermoplastic nonwoven web;
a second layer comprising thermoplastic meltblown filaments wherein the first and second layers are adjacent to each other and are bonded together; and
a non-slip coating applied to a side of at least one of the first and second layers not adjacent to the other layer.

2. The non-slip liner of claim 1, wherein the non-slip coating is applied to the second layer.

3. The non-slip liner of claim 1, wherein the non-slip coating is applied to the first layer.

4. The non-slip liner of claim 1, wherein the non-slip coating comprises an adhesive having a coefficient of friction sufficient hold the liner in place during use.

5. The non-slip liner of claim 4, wherein the adhesive comprises an aqueous based adhesive or a hot melt adhesive.

6. The non-slip liner of claim 1, wherein the nonwoven web of the first layer comprises thermoplastic spunbond filaments.

7. The non-slip liner of claim 1, wherein the nonwoven web of the first layer is selected from the group consisting of a spunbond nonwoven web, a meltblown nonwoven web, an air-laid nonwoven web, a coform nonwoven web, a bonded carded web and laminates thereof.

8. A non-slip liner comprising
a first layer comprising a thermoplastic nonwoven web;
a second layer comprising a liquid impervious nonwoven web or a film material;
a third layer comprising a thermoplastic nonwoven web; and
a non-slip coating,
wherein the second layer is between the first and third layers such that one side of the first layer is adjacent to one side of the second layer and the third layer is adjacent to the other side of the second layer and the non-slip coating is applied to a side of at least one of the first and third layers not adjacent to the second layer.

9. The non-slip liner of claim 8, wherein the second layer comprises a nonwoven web comprising thermoplastic meltblown filaments.

10. The non-slip liner of claim 9, wherein the nonwoven web of the first layer and the nonwoven web of the second layer are independently selected from the group consisting of a spunbond nonwoven web, a meltblown nonwoven web, an air-laid nonwoven web, a coform nonwoven web, a bonded carded web and laminates thereof.

11. The non-slip liner of claim 10, wherein the first and third layers each comprises a spunbond nonwoven web.

12. The non-slip liner of claim 9, wherein thermoplastic nonwoven web of the first layer and the thermoplastic meltblown filaments each, independently of one another, comprises a thermoplastic polymer selected from the group consisting of selected from the group consisting of polyolefins, polyesters, polyamides, polycarbonates, polyurethanes, polyvinylchloride, polytetrafluoroethylene, polystyrene, polyethylene terephathalate, polylactic acid and copolymers and blends thereof.

13. The non-slip liner of claim 10, wherein the non-slip coating comprises an adhesive having a coefficient of friction sufficient hold the liner in place during use.

14. The non-slip liner of claim 11, wherein the adhesive comprises an aqueous based adhesive or a hot melt adhesive.

15. The non-slip liner of claim 12, wherein the adhesive comprises a hot melt adhesive.

16. The non-slip liner of claim 7, wherein the liner has a basis weight between about 0.2 and about 12 osy (about 6.8 gsm and about 407 gsm).

17. The non-slip liner of claim 14, wherein the liner has a basis weight between about 1.0 and about 7.0 osy (about 34 gsm and about 237 gsm).

18. An article comprising
a substantially flat, substantially horizontal and upwardly facing surface; and
the non-slip liner of claim 1,
wherein the non-slip coating of the non-slip liner is in contact with the upwardly facing surface.

19. An article comprising
a substantially flat, substantially horizontal and upwardly facing surface; and
the non-slip liner of claim 8,
wherein the non-slip coating of the non-slip liner is in contact with the upwardly facing surface.
